(19) United States
(12) Patent Application Publication
(10) Pub. No.: US 2026/0249231 A1
(43) Pub. Date: Aug. 27, 2026

(54) PRESSURE SWING ADSORPTION FACILITY

(71) Applicant: Institute for Advanced Engineering, Yongin-si (KR)

(72) Inventors: Hyun Jung YU, Yongin-si (KR); Dong Kyoo PARK, Yongin-si (KR); Soo Nam PARK, Yongin-si (KR); Jae Hong RYU, Yongin-si (KR)

(21) Appl. No.: 19/550,652

(22) Filed: Feb. 26, 2026

(30) Foreign Application Priority Data
Feb. 27, 2025 (KR) 10-2025-0026170

(51) Int. Cl. B01D 53/053; B01D 53/22; C01B 3/24; C01B 3/501; C01B 3/56

(52) U.S. Cl. CPC B01D 53/053; B01D 53/229; C01B 3/24; C01B 3/501; C01B 3/56; B01D 2256/16; B01D 2257/7025; C01B 2203/0266; C01B 2203/0405; C01B 2203/042; C01B 2203/1241; C01P 2006/80

(57) ABSTRACT

A pressure swing adsorption facility includes: a pyrolysis reactor forming a mixed gas by pyrolyzing methane; a compressor compressing the mixed gas; a pressure swing adsorption device purifying the mixed gas compressed by the compressor to separate the mixed gas into a product gas and an off-gas; a membrane process device separating the off-gas into a hydrogen-containing gas and a residual gas; and a flow channel providing a passage through which at least one of methane, the mixed gas, the product gas, the hydrogen-containing gas, and the off-gas, between the pyrolysis reactor, the compressor, the pressure swing adsorption device, and the membrane process device. The flow channel includes: a methane return path providing a passage for directing the residual gas to the pyrolysis reactor.

### CROSS REFERENCE TO RELATED APPLICATION

The present application claims priority to Korean Patent Application No. 10-2025-0026170, filed on February 27, 2025, the entire contents of which are incorporated here for all purposes by this reference.

### TECHNICAL FIELD

The present disclosure relates to a pressure swing adsorption facility.

### BACKGROUND

Currently, pressure swing adsorption (PSA) processes commercialized as gas separation and purification processes include air drying processes, hydrogen purification and recovery processes, CO₂ recovery processes from flue gas, trace component removal processes from mixed gases, and oxygen and nitrogen separation and concentration processes from air. Research is actively conducted to expand the applicability of the PSA process and to improve the process.

However, a conventional PSA process has a problem in that when carbon dioxide (CO₂) is separated or desorbed, hydrogen is discharged together with the off-gas, resulting in a high loss rate of hydrogen. Furthermore, the conventional PSA process has a problem in that a large amount of carbon dioxide may be discharged into the atmosphere.

### SUMMARY

An object of the present disclosure is to provide a pressure swing adsorption facility increasing the recovery rate of hydrogen while increasing the purity of hydrogen.

In accordance with a first aspect of the present disclosure, there is provided a pressure swing adsorption facility, including: a pyrolysis reactor forming a mixed gas by pyrolyzing methane; a compressor compressing the mixed gas; a pressure swing adsorption device purifying the mixed gas compressed by the compressor to separate the mixed gas into a product gas and an off-gas; a membrane process device separating the off-gas into a hydrogen-containing gas and a residual gas; and a flow channel providing a passage through which at least one of methane, the mixed gas, the product gas, the hydrogen-containing gas, and the off-gas, between the pyrolysis reactor, the compressor, the pressure swing adsorption device, and the membrane process device, wherein the flow channel includes: a methane return path providing a passage for directing the residual gas to the pyrolysis reactor.

Further, the mixed gas may include hydrogen and methane, the residual gas may include a methane-containing gas, and the product gas may include 99.9 vol% to 99.99 vol% of hydrogen and 0.01 vol% to 0.1 vol% of methane.

Further, the flow channel may further include: a hydrogen return path providing a passage for flowing the hydrogen-containing gas to the compressor.

Further, the membrane process device may include: a non-permeate unit into which the off-gas discharged from the pressure swing adsorption device is introduced; a permeate unit into which the hydrogen-containing gas separated from the off-gas is introduced; and a separation membrane partitioning the non-permeate unit and the permeate unit and separating the hydrogen-containing gas from the off-gas.

Further, the pressure swing adsorption facility may further include: a pump applying pressure to the mixed gas introduced into the membrane process device to separate the product gas from the mixed gas through the separation membrane.

Further, the flow channel may further include: a supply path providing a passage through which the methane supplied from an external source flows to the pyrolysis reactor, and the supply path may be in communication with the methane return path so that the residual gas discharged from the methane return path is introduced into the supply flow path.

Further, the pressure swing adsorption facility may further include: a first mixing chamber disposed in the supply path to mix the methane supplied from the external source with the residual gas discharged from the methane return path, and the methane mixed with the residual gas in the first mixing chamber may be introduced into the pyrolysis reactor.

Further, the flow channel may further include: a flow path connected to the pyrolysis reactor, the compressor, and the pressure swing adsorption device to provide a passage through which the mixed gas flows, and the flow path may communicate with the hydrogen return path so that the product gas discharged from the hydrogen return path flows into the flow path.

Further, the pressure swing adsorption facility may further include: a second mixing chamber disposed in the flow path to mix the mixed gas discharged from the pyrolysis reactor with the hydrogen-containing gas discharged from the hydrogen return path, and the mixed gas mixed with the hydrogen-containing gas in the second mixing chamber may be introduced into the compressor.

The pressure swing adsorption facility may further include: a receiver tank for storing the mixed gas compressed by the compressor and discharging the stored mixed gas to the pressure swing adsorption device; and a storage tank for storing the product gas separated by the pressure swing adsorption device.

In accordance with a second aspect of the present disclosure, there is provided a gas generation method of a pressure swing adsorption facility, including: pyrolyzing methane in a pyrolysis reactor so that a mixed gas is formed; compressing the mixed gas in a compressor; purifying the compressed mixed gas in a pressure swing adsorption device and separating the compressed mixed gas into a product gas and an off-gas; separating the off-gas into a hydrogen-containing gas and a residual gas in a membrane process device; returning the separated hydrogen-containing gas to the compressor; and returning the separated residual gas to the pyrolysis reactor.

Further, in the pyrolysis step, the pyrolysis reactor may pyrolyze the returned residual gas with the methane, and in the compressing step, the compressor may compress the returned hydrogen-containing gas with the mixed gas.

Further, the mixed gas formed in the pyrolysis step may include hydrogen and methane, the separated residual gas may include a methane-containing gas, and the separated product gas may include 99.9 vol% to 99.99 vol% of hydrogen and 0.01 vol% to 0.1 vol% of methane.

An embodiment of the present disclosure provides an effect of improving the recovery rate by returning the methane-containing gas and the hydrogen-containing gas of the off-gas discharged from the PSA device.

Furthermore, an embodiment of the present disclosure provides an effect of improving the yield of the pyrolysis reaction and increasing the purity of hydrogen by returning the methane-containing gas and the hydrogen-containing gas.

Furthermore, an embodiment of the present disclosure provides an effect of not discharging carbon dioxide into the atmosphere by generating a product gas from methane and returning the methane-containing gas and the hydrogen-containing gas.

### BRIEF DESCRIPTION OF THE DRAWINGS

FIG. 1 is a block diagram of a pressure swing adsorption facility according to an embodiment of the present disclosure.

FIG. 2 is a flowchart of a gas generation method of a pressure swing adsorption facility according to the embodiment of the present disclosure.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being 'supported' by, 'connected' to, or 'contacted' with another element, it should be understood that the element may be directly supported by, connected to, or contacted with another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side, the lower side, and the side surface, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, a pressure swing adsorption facility 1 according to an embodiment of the present disclosure will be described with reference to the drawings.

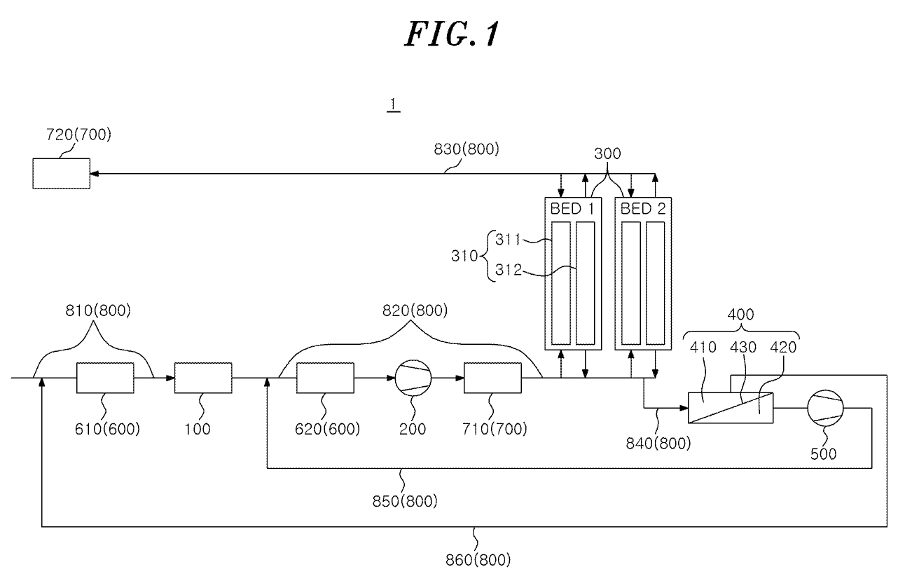

Referring to FIG. 1, the pressure swing adsorption facility 1 may generate a high-purity product gas. The pressure swing adsorption facility 1 may generate a product gas using methane (CH₄) supplied from an external source. The product gas generated in this pressure swing adsorption facility 1 may include 99.9 vol% to 99.99 vol% of hydrogen and 0.01 vol% to 0.1 vol% of methane. In other words, the product gas generated in the pressure swing adsorption facility 1 may be high-purity hydrogen. The pressure swing adsorption facility 1 may include a pyrolysis reactor 100, a compressor 200, a PSA device 300, a membrane process device 400, a pump 500, a chamber 600, a tank 700, and a flow channel 800.

The pyrolysis reactor 100 may form a mixed gas by pyrolyzing incoming methane. Methane may be decomposed into hydrogen (H₂) and solid carbon (C) in the pyrolysis reactor 100. The carbon may be processed as a byproduct or may be separately recovered and processed, but is not limited thereto. The mixed gas may include hydrogen and methane. For example, the mixed gas may include 5 vol% to 15 vol% of methane and 85 vol% to 95 vol% of hydrogen.

The compressor 200 may compress the mixed gas discharged from the pyrolysis reactor 100. The compressor 200 may be disposed in the flow channel 800 to be located between the pyrolysis reactor 100 and the PSA device 300. In other words, the mixed gas compressed by the compressor 200 may flow to the PSA device 300. By the compressor 200, the pressure of the mixed gas may be increased and adjusted to a pressure required by the PSA device 300.

The PSA (pressure swing adsorption) device 300 may purify the compressed mixed gas to separate the compressed mixed gas into a product gas and an off-gas. The product gas may include 99.9 vol% to 99.99 vol% of hydrogen and 0.01 vol% to 0.1 vol% of methane. In other words, the product gas may be high-purity hydrogen. The off-gas may include impurities formed as the product gas is separated from the mixed gas. For example, the off-gas may include one or more of CO, CH₄, CO₂, N₂, H₂0, 0₂, and H₂. Furthermore, the PSA device 300 may include a plurality of purification columns 310.

The plurality of purification columns 310 may receive the mixed gas and purify the mixed gas to separate the product gas. When the mixed gas passes through the plurality of purification columns 310, the plurality of purification columns 310 may adsorb the off-gas and allow the product gas to pass therethrough. The off-gas adsorbed on the plurality of purification columns 310 may be detached from the plurality of purification columns 310 when the internal pressure of the plurality of purification columns 310 is decreased. The plurality of purification columns 310 may include a first purification column 311 and a second purification column 312.

The first purification column 311 and the second purification column 312 may repeat adsorption and desorption alternately. For example, when the mixed gas first passes through the first purification column 311, the off-gas may be adsorbed on the first purification column 311 and the product gas may pass through. When the mixed gas passes through the second purification column 312, the off-gas may be adsorbed on the second purification column 312 and the product gas may be separated. Thereafter, when the internal pressure of the first purification column 311 is decreased, the off-gas adsorbed on the first purification column 311 may be discharged to the outside of the PSA device 300. Furthermore, when the internal pressure of the second purification column 312 is decreased, the residual gas adsorbed on the second purification column 312 may be discharged to the outside of the PSA device 300.

The membrane process device 400 may separate a hydrogen-containing gas from the off-gas discharged from the PSA device 300. The membrane process device 400 may include a non-permeate unit 410, a permeate unit 420, and a separation membrane 430.

The off-gas may be introduced into the non-permeate unit 410. In other words, the off-gas discharged from the PSA device 300 may be introduced into the non-permeate unit 410. Furthermore, the non-permeate unit 410 may discharge the residual gas of the off-gas not passing through the separation membrane 430 to the outside. The residual gas may be a methane-containing gas.

The hydrogen-containing gas of the off-gas may be introduced into the permeate unit 420. In other words, the hydrogen-containing gas included in the off-gas may pass through the separation membrane 430 and be accommodated in the permeate unit 420. The permeate unit 420 may discharge the hydrogen-containing gas to the outside.

The separation membrane 430 may partition the non-permeate unit 410 and the permeate unit 420 and separate the hydrogen-containing gas and the residual gas included in the off-gas. In one embodiment, the separation membrane 430 may allow the hydrogen-containing gas to pass therethrough and to prevent the methane-containing gas from passing therethrough. The residual gas may be returned to the pyrolysis reactor by a methane return channel 860, which will be described later. The hydrogen-containing gas may be returned to the compressor by a hydrogen return channel 850, which will be described later. The ratio of the returned residual gas to the hydrogen-containing gas may be from 50 vol%:50 vol% to 95 vol%:5 vol%.

The pump 500 may apply pressure to the membrane process device 400. By the pump 500, the off-gas may be pressurized toward the separation membrane 430 and separated into a hydrogen-containing gas and a residual gas. The pump 500 may be disposed in the hydrogen return channel 850, which will be described later, but is not limited thereto. In other words, the pump 500 may also be disposed in a gas discharge channel 840, which will be described later.

A plurality of chambers 600 may be formed to accommodate a gas. Furthermore, the plurality of chambers 600 may be arranged to mix gases. The plurality of chambers 600 may include a first mixing chamber 610 and a second mixing chamber 620.

The first mixing chamber 610 may mix the methane supplied from an external source and the residual gas. In other words, in the first mixing chamber 610, methane may be mixed with the methane-containing gas returned by the methane return channel 860. The methane mixed in the first mixing chamber 610 may flow to the pyrolysis reactor 100. For example, the ratio of the residual gas to the methane mixed in the first mixing chamber 610 may be from 5 vol%:95 vol% to 35 vol%:65 vol%.

The second mixing chamber 620 may mix the mixed gas and the hydrogen-containing gas. In other words, in the second mixing chamber 620, the mixed gas may be mixed with the hydrogen-containing gas returned by the hydrogen return channel 850. For example, the returned hydrogen-containing gas may be mixed with the hydrogen of the mixed gas. Furthermore, the second mixing chamber 620 may be disposed in the flow channel 800 to be disposed between the pyrolysis reactor 100 and the compressor 200. The mixed gas mixed in the second mixing chamber 620 may flow to the compressor 200. For example, the ratio of the hydrogen-containing gas to the mixed gas mixed in the second mixing chamber 620 may be from 0.5 vol%:99.5 vol% to 20 vol%:80 vol%.

A plurality of tanks 700 may be formed to accommodate a gas. The plurality of tanks 700 may include a receiver tank 710 and a storage tank 720.

The receiver tank 710 may temporarily store the mixed gas. The receiver tank 710 may be disposed in the flow channel 800 to be disposed between the compressor 200 and the PSA device 300. The mixed gas compressed in the compressor 200 is introduced into the receiver tank 710, and the receiver tank 710 may discharge the compressed mixed gas to the PSA device. This receiver tank 710 may maintain the pressure of the mixed gas constant and supply the mixed gas to the PSA device. Furthermore, the receiver tank 710 may supply the compressed mixed gas to the PSA device at a constant rate.

The storage tank 720 may accommodate the product gas discharged from the PSA device 300. In other words, the storage tank 720 may store high-purity hydrogen. The storage tank 720 may be disposed in a hydrogen discharge channel 830.

The flow channel 800 is connected to the pyrolysis reactor 100, the compressor 200, the PSA device 300, the membrane process device 400, the pump 500, the chamber 600, and the tank 700, and may provide a passage through which methane, a mixed gas, a product gas, a hydrogen-containing gas, an off-gas, and a residual gas flow. The flow channel 800 may include a supply path 810, a flow path 820, a hydrogen discharge path 830, a gas discharge path 840, a hydrogen return path 850, and a methane return path 860.

The supply path 810 may be connected to the first mixing chamber 610 and the pyrolysis reactor 100 to provide a passage through which methane flows. Furthermore, methane introduced from an external source may be introduced into the supply path 810. By the supply path 810, methane may flow to the pyrolysis reactor 100 by passing through the first mixing chamber 610. Furthermore, the supply path 810 may be in fluid communication with the methane return path 860. In other words, the methane-containing gas discharged from the methane return path 860 may be introduced into the supply path 810. The methane-containing gas may flow to the first mixing chamber 610 by the supply path 810.

The flow path 820 may be connected to the pyrolysis reactor 100, the second mixing chamber 620, the compressor 200, the receiver tank 710, and the PSA device 300 to provide a passage through which the mixed gas flows. The mixed gas discharged from the pyrolysis reactor 100 may flow to the PSA device 300 by passing through the second mixing chamber 620, the compressor 200, and the receiver tank 710. The flow channel 820 may be in fluid communication with the hydrogen return path 850, and the hydrogen-containing gas discharged from the hydrogen return path 850 may be introduced thereinto. The point where the flow channel 820 and the hydrogen return path 850 are in fluid communication may be located between the pyrolysis reactor 100 and the second mixing chamber 620 in the flow channel 820. The hydrogen-containing gas may flow to the second mixing chamber 620 by the flow channel 820.

The hydrogen discharge path 830 may be connected to the PSA device 300 and the storage tank 720 to provide a passage through which the product gas flows. By the hydrogen discharge path 830, the product gas discharged from the PSA device 300 may flow to the storage tank 720 and be stored.

The gas discharge path 840 may be connected to the PSA device 300 and the membrane process device 400 to provide a passage through which the residual gas flows. By the gas discharge path 840, the residual gas discharged from the PSA device 300 may flow to the membrane process device 400.

The hydrogen return path 850 may be connected to the permeate unit 420 and the flow channel 820 to provide a passage through which the hydrogen-containing gas flows. By the hydrogen return path 850, the hydrogen-containing gas discharged from the permeate unit 420 may be returned to the flow channel 820.

The methane return path 860 may be connected to the non-permeate unit 410 and the supply path 810 to provide a passage through which the methane-containing gas flows. By the methane return path 860, the methane-containing gas discharged from the non-permeate unit 410 may be returned to the supply path 810.

Hereinafter, the operation and effects of the pressure swing adsorption facility 1 according to the embodiment of the present disclosure will be described.

Methane may be introduced into the pressure swing adsorption facility 1 from an external source. Methane may be mixed with the residual gas returned by the methane return path 860 in the first mixing chamber 610 and pyrolyzed in the pyrolysis reactor 100 to be formed into a mixed gas. The mixed gas may be mixed with the hydrogen-containing gas returned by the hydrogen return path 850 in the second mixing chamber 620 and compressed by the compressor 200. The compressed mixed gas may be temporarily stored in the receiver tank 710 and then separated into a product gas and an off-gas in the PSA device 300. The product gas discharged from the PSA device 300 may be stored in the storage tank 720. Furthermore, the off-gas discharged from the PSA device 300 may be separated into a residual gas and a hydrogen-containing gas in the membrane process device 400. The hydrogen-containing gas may be returned by the hydrogen return path 850 and mixed with the mixed gas. Furthermore, the residual gas may be returned by the methane return path 860 and mixed with the methane supplied from the external source.

Since the methane-containing gas and the hydrogen-containing gas of the off-gas discharged from the PSA device 300 of the pressure swing adsorption facility 1 may be returned, the recovery rate may be improved.

Furthermore, since the methane-containing gas and the hydrogen-containing gas may be returned, the yield of the pyrolysis reaction may be improved, and the purity of hydrogen may be increased.

Furthermore, since the product gas is generated by methane and the methane-containing gas and the hydrogen-containing gas may be returned, carbon dioxide is not discharged into the atmosphere.

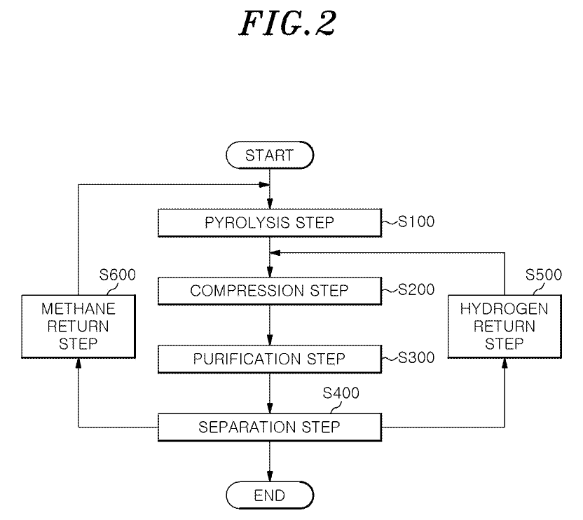

Hereinafter, a gas generation method of the pressure swing adsorption facility according to the embodiment of the present disclosure will be described with reference to FIG. 2.

The gas generation method of the pressure swing adsorption facility 1 is a method for generating a product gas including high-purity hydrogen. The gas generation method of the pressure swing adsorption facility 1 may include a pyrolysis step S100, a compression step S200, a purification step S300, a separation step S400, a hydrogen return step S500, and a methane return step S600.

The pyrolysis step S100 is a step in which methane is pyrolyzed in the pyrolysis reactor 100 so that a mixed gas is formed. In the pyrolysis step S100, the pyrolysis reactor 100 may pyrolyze methane introduced from an external source. Furthermore, in the pyrolysis step S100, the pyrolysis reactor 100 may pyrolyze the returned residual gas together with the methane. In other words, in the pyrolysis step S100, methane and the residual gas may be mixed and pyrolyzed to be formed into a mixed gas. The mixed gas formed in the pyrolysis step S100 may include hydrogen and methane.

The compression step S200 is a step in which the mixed gas is compressed by the compressor 200. A compressed mixed gas may be formed in the compression step S200. Furthermore, the compressor 200 in the compression step S200 may compress the returned hydrogen-containing gas together with the mixed gas. In other words, in the compression step S200, the mixed gas mixed with the hydrogen-containing gas may be compressed.

The purification step S300 is a step in which the compressed mixed gas is purified in the PSA device 300 and separated into a product gas and an off-gas. The product gas separated in the purification step S300 may include 99.9 vol% to 99.99 vol% of hydrogen and 0.01 vol% to 0.1 vol% of methane. Furthermore, in the purification step S300, the product gas may be stored in the storage tank 720.

The separation step S400 is a step in which the off-gas is separated into a hydrogen-containing gas and a residual gas in the membrane process device 400. In other words, in the separation step S400, the off-gas may be separated into a hydrogen-containing gas and a residual gas while passing through the separation membrane 430.

The hydrogen return step S500 is a step in which the hydrogen-containing gas is returned so that the hydrogen-containing gas separated in the separation step S400 flows to the compressor 200. In the hydrogen return step S500, the hydrogen-containing gas may flow to the compressor 200 by the hydrogen return path 850. The hydrogen-containing gas returned in the hydrogen return step S500 may be compressed together with the mixed gas in the compressor 200 in the compression step S100.

The methane return step S600 is a step in which the residual gas is returned so that the residual gas separated in the separation step S400 flows to the pyrolysis reactor 100. The residual gas may include a methane-containing gas. In other words, in the methane return step S600, the methane-containing gas may flow to the pyrolysis reactor 100 by the methane return path 860. The methane-containing gas returned in the methane return step S600 may be pyrolyzed together with methane in the pyrolysis reactor 100 in the pyrolysis step S100.

Hereinafter, the effects of the gas generation method of the pressure swing adsorption facility 1 according to the embodiment of the present disclosure will be described.

In the gas generation method of the pressure swing adsorption facility 1, since the methane-containing gas and the hydrogen-containing gas may be returned, the yield of the pyrolysis reaction may be improved, and the purity of hydrogen may be increased.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

What is claimed is:

1. A pressure swing adsorption facility, comprising:
a pyrolysis reactor forming a mixed gas by pyrolyzing methane;
a compressor compressing the mixed gas;
a pressure swing adsorption device purifying the mixed gas compressed by the compressor to separate the mixed gas into a product gas and an off-gas;
a membrane process device separating the off-gas into a hydrogen-containing gas and a residual gas; and
a flow channel providing a passage through which at least one of methane, the mixed gas, the product gas, the hydrogen-containing gas, and the off-gas, between the pyrolysis reactor, the compressor, the pressure swing adsorption device, and the membrane process device,
wherein the flow channel includes: a methane return path providing a passage for directing the residual gas to the pyrolysis reactor.

2. The pressure swing adsorption facility of claim 1, wherein the mixed gas comprises hydrogen and methane,
wherein the residual gas includes a methane-containing gas, and
wherein the product gas includes 99.9 vol% to 99.99 vol% of hydrogen and 0.01 vol% to 0.1 vol% of methane.

3. The pressure swing adsorption facility of claim 1, wherein the flow channel further comprises: a hydrogen return path providing a passage for flowing the hydrogen-containing gas to the compressor.

4. The pressure swing adsorption facility of claim 1, wherein the membrane process device comprises:
a non-permeate unit into which the off-gas discharged from the pressure swing adsorption device is introduced;
a permeate unit into which the hydrogen-containing gas separated from the off-gas is introduced; and
a separation membrane partitioning the non-permeate unit and the permeate unit and separating the hydrogen-containing gas from the off-gas.

5. The pressure swing adsorption facility of claim 4, further comprising:
a pump applying pressure to the mixed gas introduced into the membrane process device to separate the product gas from the mixed gas through the separation membrane.

6. The pressure swing adsorption facility of claim 1, wherein the flow channel further comprises:
a supply path providing a passage through which the methane supplied from an external source flows to the pyrolysis reactor, and
wherein the supply path is in communication with the methane return path so that the residual gas discharged from the methane return path is introduced into the supply flow path.

7. The pressure swing adsorption facility of claim 6, further comprising:
a first mixing chamber disposed in the supply path to mix the methane supplied from the external source with the residual gas discharged from the methane return path,
wherein the methane mixed with the residual gas in the first mixing chamber is introduced into the pyrolysis reactor.

8. The pressure swing adsorption facility of claim 3, wherein the flow channel further comprises:
a flow path connected to the pyrolysis reactor, the compressor, and the pressure swing adsorption device to provide a passage through which the mixed gas flows, and
wherein the flow path communicates with the hydrogen return path so that the product gas discharged from the hydrogen return path flows into the flow path.

9. The pressure swing adsorption facility of claim 8, further comprising:
a second mixing chamber disposed in the flow path to mix the mixed gas discharged from the pyrolysis reactor with the hydrogen-containing gas discharged from the hydrogen return path,
wherein the mixed gas mixed with the hydrogen-containing gas in the second mixing chamber is introduced into the compressor.

10. The pressure swing adsorption facility of claim 1, further comprising:
a receiver tank for storing the mixed gas compressed by the compressor and discharging the stored mixed gas to the pressure swing adsorption device; and
a storage tank for storing the product gas separated by the pressure swing adsorption device.

11. A gas generation method of a pressure swing adsorption facility, comprising:
pyrolyzing methane in a pyrolysis reactor so that a mixed gas is formed;
compressing the mixed gas in a compressor;
purifying the compressed mixed gas in a pressure swing adsorption device and separating the compressed mixed gas into a product gas and an off-gas;
separating the off-gas into a hydrogen-containing gas and a residual gas in a membrane process device;
returning the hydrogen-containing gas separated in the separating to the compressor; and
returning the residual gas separated in the separating to the pyrolysis reactor.

12. The gas generation method of claim 11, wherein in the pyrolyzing, the pyrolysis reactor pyrolyzes the residual gas returned in the returning of the residual gas together with the methane, and
wherein in the compressing, the compressor compresses the hydrogen-containing gas returned in the returning of the hydrogen-containing gas together with the mixed gas.

13. The gas generation method of claim 11, wherein the mixed gas formed in the pyrolyzing includes hydrogen and methane,
wherein the residual gas separated in the separating includes a methane-containing gas, and
wherein the product gas separated in the purifying includes 99.9 vol% to 99.99 vol% of hydrogen and 0.01 vol% to 0.1 vol% of methane.
